(19) United States
(12) Patent Application Publication
(10) Pub. No.: US 2024/0141658 A1
(43) Pub. Date: May 2, 2024

(54) LIFTING DEVICE FOR ERECTING COLUMNS AND RELATED METHOD

(71) Applicant: GROUPE CANAM INC., Saint-Georges (CA)

(72) Inventor: Pier-Luc Samson, Rimouski (CA)

(21) Appl. No.: 18/109,701

(22) Filed: Feb. 14, 2023

Related U.S. Application Data
(60) Provisional application No. 63/381,045, filed on Oct. 26, 2022.

(51) Int. Cl. E04G 21/14; B66C 1/66

(52) U.S. Cl. CPC E04G 21/142; B66C 1/66

(57) ABSTRACT

A lifting device for erecting a structure having splice plates is provided. The lifting device having a body adapted to engage the splice plates and having an attachment site adapted to be coupled to a hoisting apparatus. The body further has an opening defined therethrough and adapted to align with the plate openings. The lifting device also has a connection assembly comprising a support structure connected to the body and having a cradle, and a releasable connector adapted to extend through the plate openings and the opening. The cradle is adapted to secure the releasable connector through the splice plates and the body when the body is lifted via the hoisting apparatus. The connection assembly also has a disconnection mechanism operable from a ground surface to remove the releasable connector from the plate openings and the opening to disconnect the body and the structure.

### CROSS-REFERENCE TO RELATED APPLICATIONS

This application claims priority under 35 USC § 119(e) of U.S. Provisional Application No. 63/381,045, filed Oct. 26, 2022, entitled “LIFTING DEVICE FOR ERECTING COLUMNS AND RELATED METHOD”, the entirety of which is hereby incorporated by reference.

### TECHNICAL FIELD

The technical field generally relates to apparatuses, systems and methods for erecting various structures, and more specifically relates to a lifting device connectable to steel structures for erection thereof via operation of a crane.

### BACKGROUND

The construction of structures, such as buildings, traditionally require the installation of steel beams or columns. These columns are typically transported, delivered and dumped at a construction site where they can be erected, for example, using a crane to lift the columns from the ground to a vertical position. A lifting device or attachment can be used to couple the crane to the column, thereby enabling the crane to lift the column.

The attachment is attached to a top portion of the columns to facilitate vertically lifting the columns with the crane. Once erected (e.g., once in their vertical position), the column is secured in a desired location and the crane can be disconnected. The lifting attachment is removed from the recently erected column and installed on another column to repeat the process. In order to remove the attachment from an installed column, the top portion, where the attachment is connected, must be reached. The attachment is generally manually disconnected from each column and connected to the next, which can include lifting a person to the top of each newly installed column to disconnect the attachment.

Therefore, there is a need for an improved system or device that at least mitigates some of the known issues from existing systems used to lift and erect structural elements such as steel beams and columns.

### SUMMARY

According to an aspect of the present disclosure, a lifting device connectable to a structure to be erected and having a pair of splice plates having respective plate openings and being spaced from one another to define a gap therebetween is provided. The lifting device includes a body shaped and adapted to engage the gap between the splice plates, the body having an attachment site adapted to be coupled to a hoisting apparatus operable to lift the body, and further has an opening defined therethrough and extending along a length thereof, the opening being positioned in a manner enabling alignment thereof with the plate openings when the body is engaged between the splice plates; a connection assembly comprising: a support structure connected to the body and having a cradle, a releasable connector shaped and sized to extend through the plate openings and the opening to connect the body to the structure, the cradle being adapted to receive a portion of the releasable connector therein to at least partially secure the releasable connector in position through the plate openings and the opening when the body is lifted via the hoisting apparatus; and a disconnection mechanism operatively coupled to the releasable connector and operable to remove the releasable connector from the plate openings and the opening to disconnect the body from the structure, wherein the disconnection mechanism is operable from a ground surface after erecting the structure using the hoisting apparatus.

According to an embodiment, the attachment site of the body includes an aperture defined through the body and spaced from the opening.

According to an embodiment, the support structure comprises a first support section connected to and extending from the body and a second support section connected to and extending from the first support section, the second support section being provided with the cradle at a bottom end thereof.

According to an embodiment, the opening has a top end and a bottom end, and wherein the second support section is shaped and adapted to position the cradle in alignment with the bottom end of the opening.

According to an embodiment, the support structure comprises a third support section comprising a hoop, the third support section being connected to and extending from the first support section to position the hoop in alignment with the top end of the opening.

According to an embodiment, the first support section comprises a first U-shaped rod connected to and extending from the body, and wherein the second and third support sections comprise second and third U-shaped rods, respectively, connected to and extending from the first U-shaped rod, each of the U-shaped rods having a rounded end.

According to an embodiment, the cradle is defined at the rounded end of the second U-shaped rod, and wherein the hoop is provided at the rounded end of the third U-shaped rod.

According to an embodiment, the first support section is substantially perpendicular relative to the body.

According to an embodiment, the second support section is substantially parallel to at least one of the third support element and the body.

According to an embodiment, the disconnection mechanism comprises a release rope connected to the releasable connector and extending through the hoop, the release rope having a first segment extending between the releasable connector and the hoop, and a second segment extending from the hoop opposite the first segment, the disconnection mechanism being operable by applying a pulling force on the second segment, the first segment being adapted to redirect the pulling force in alignment with the plate openings and the opening to disconnect the releasable connector.

According to an embodiment, the cradle comprises one or more panels connected proximate a distal end of the second support section, the one or more panels defining a slot shaped and configured to receive the portion of the releasable connector.

According to an embodiment, the releasable connector is adapted to engage the slot from a single direction.

According to an embodiment, the releasable connector comprises a pin adapted to extend through the plate openings and the opening, the pin comprising a pin head having a disk-shape and a pin body extending along a longitudinal axis, the pin head being shaped and sized to prevent movement of the pin along the longitudinal axis when engaged within the slot.

According to an embodiment, the disconnection mechanism comprises a safety rope adapted to connect the pin to the support structure and retain the pin attached to the support structure upon operation of the disconnection mechanism to disconnect the pin from the plate openings and the opening.

According to an embodiment, the structure is a steel column.

According to another aspect, a method of erecting a structure using the lifting device as defined above, comprising: engaging the body between splice plates of the structure at ground level to align a first end of the opening with plate openings of the splice plates; inserting the releasable connector through the aligned plate openings and opening of the body; sliding the body between the splice plates to align a second end of the opening with the plate openings and engage the cradle with the releasable connector; hoisting the body vertically higher to raise the structure in a generally vertical position; securing a bottom end of the structure in a desired location; lowering the body between the splice plates to align the first end of the opening with the plate openings; and operating the disconnection mechanism from the ground level.

According to an embodiment, the structure is a steel column.

According to another aspect, a method of erecting one or more structural elements using a lifting device is provided. The method includes: engaging the lifting device at a top end of a first structural element; connecting the lifting device to the structural element via a connector; locking the connector in place by hoisting the lifting device vertically higher, thereby simultaneously hoisting the first structural element; positioning the first structural element in a generally vertical position; securing a bottom end of the first structural element in a desired location; and operating a disconnection mechanism from a ground surface.

According to another aspect, a lifting attachment for erecting a structure using a hoisting apparatus is provided. The lifting attachment includes a body connectable to a top end of the structure, the body being adapted to be coupled to the hoisting apparatus; a connector adapted to extend through the body and the structure; a cradle coupled to the body and adapted to receive part of the connector and secure the connector in position through the body and the structure when hoisting the body with the hoisting apparatus, thereby securing the body to the structure; and a disconnection mechanism coupled to the connector and being operable to remove the connector from the body and the structure once the structure is erected.

According to an embodiment, the disconnection mechanism is configured to be operable only when the connector is disengaged from the cradle.

According to an embodiment, once the structure is erected, the disconnection mechanism is configured to be operable from a ground surface.

### BRIEF DESCRIPTION OF THE DRAWINGS

FIG. 1 is a perspective view of a lifting device according to an embodiment.

FIG. 2 is a perspective view of the lifting device shown in FIG. 1 and coupled to a structural element to be erected, according to an embodiment.

FIG. 3 is an enlarged view of the lifting device shown in FIG. 2, showing a safety cable and a release cable coupled to the lifting device, according to an embodiment.

FIGS. 4 to 6 are perspective views of the lifting device shown in FIG. 1, showing a connection method of a releasable pin to a body of the lifting device, according to an embodiment.

FIG. 7 is a perspective view of the lifting device coupled to a top end of the structural element shown in FIG. 2, showing a person at ground level operating the release cable, according to an embodiment.

FIG. 8 is a bottom perspective view of the lifting device coupled to a structural element, and further coupled to a hoisting cable or hoisting apparatus, according to an embodiment.

### DETAILED DESCRIPTION

As will be explained below in relation to various embodiments, the present disclosure describes apparatuses, systems and methods for erecting various structures, such as steel structures, such as vertical beams and/or columns used for the construction of buildings, for example.

In one aspect, the present disclosure relates to a lifting device connectable to the structure to be erected, and disconnectable therefrom from a ground surface once the structure has been erected. For instance, during the construction of a building, various components and/or structures, such as vertical beams and columns, which are generally delivered and/or assembled horizontally, are erected in order to be secured in a substantially vertical position. It should be understood that, as used herein, the expression “erection”, “erected” and variants thereof can refer to the action of constructing and/or lifting a structure or object in a generally upright or vertical position.

The lifting device can be removably connected to a top end of the structure (e.g., steel columns) and coupled to a crane. The crane can then be operated to lift the column vertically, which can then be anchored/secured in place at a base thereof. The lifting device also includes a selectively operable connection assembly enabling disconnection of the lifting device from the newly erected structure. The connection assembly can be operated from a ground surface, thereby preventing the need to climb the structure and/or use lifting equipment (e.g., scaffoldings, suspended platforms, etc.) to disconnect the lifting device coupled at the top end of the structure. The lifting device can then be used for other structures, such as other columns or vertical beams, in a similar manner for erection thereof, among others, in a simpler, easier, faster, more accurate, more effective, more functional, more reliable and/or more versatile manner than what is possible with other conventional devices and/or apparatus.

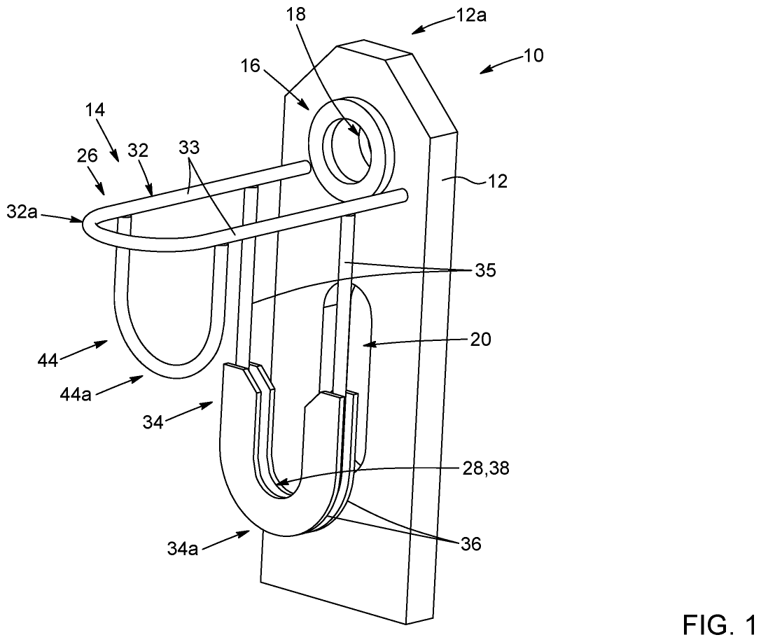

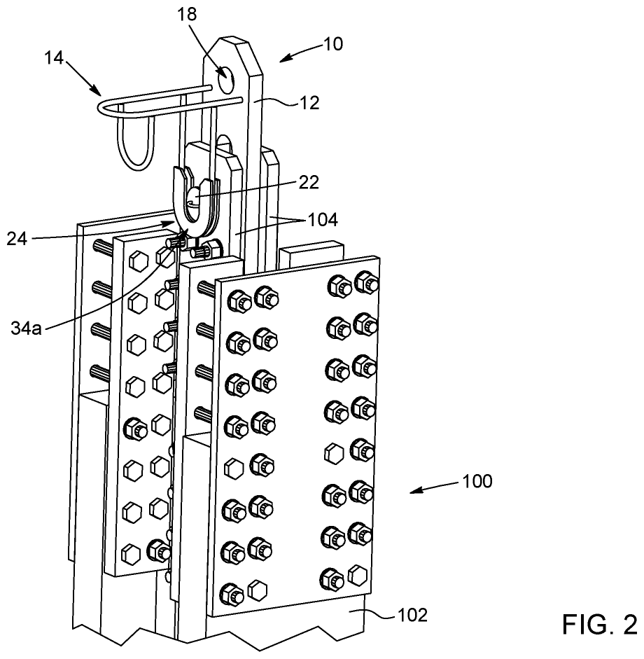

With reference to FIGS. 1 and 2, a lifting device 10 is shown according to a possible embodiment. The lifting device 10 includes a body 12 and a connection assembly 14 connected to the body 12. The body 12 can be plate-shaped and therefore referred to as a “plate body 12”. It should be noted that, in some embodiments, the plate body 12 can extend in a single plane, and is therefore flat. As will be described further below, the plate body 12 is configured to be coupled to a structure 100, such as a steel column, via the connection assembly 14, and can be further connected to a hoisting apparatus which can be operated to raise and move the lifting device 10. The structure 100 is thereby lifted, via its connection to the lifting device, and can thus be erected, positioned and secured at a desired location. The connection assembly 14 can then be actuated to enable disconnection of the body 12 from the structure, thereby allowing the body 12 to be moved relative to the previously erected and secured structure, and connected to another structure, such as another steel column, for erection, positioning and securing thereof at another location, for example.

The body 12 can include an attachment site 16 adapted to enable connection of the body 12 to a hoisting apparatus, such as a crane, for example. In this embodiment, the attachment site 16 includes an aperture 18 defined proximate a top end 12a of the body 12 through which a component of the hoisting apparatus (e.g., cables, hooks, etc.) can extend for connection therewith. For instance, the hoisting apparatus can include a crane provided with a belt, a strap or a shackle adapted to extend through the aperture 18 for connecting the body 12 to the hoisting apparatus. It is thus noted that, when the lifting device 10 is secured to a structure, operation of the hoisting apparatus (e.g., the crane) displaces the lifting device 10 along with the structure for positioning the structure in the desired location and/or configuration. It is appreciated that the body 12 can be connected to the hoisting apparatus in any other suitable manner, and that the attachment site 16 can have any other suitable configuration to enable said connection.

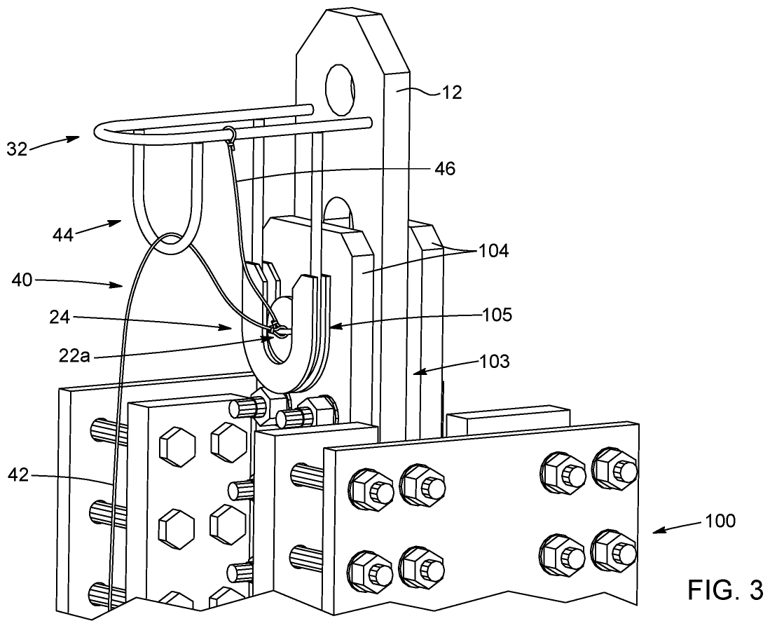

In some embodiments, the connection assembly 14 can enable connection of the body 12 to the structure 100, with the connection assembly 14 being selectively operable to permit disconnection of the body 12 from the structure 100, such as after positioning and/or securing the structure in a desired location. In this embodiment, the body 12 includes a connection opening 20 defined therethrough and the connection assembly 14 includes a releasable connector, e.g., a releasable pin 22 shaped and adapted to extend through the connection opening 20. As seen in FIGS. 2 and 3, the releasable pin 22 can be adapted to extend through one or more parts of the structure 100, in addition to extending through the body 12, thereby connecting these elements together. The releasable pin 22 can have a head portion 22a having a greater outer diameter than a longitudinal portion 22b thereof (e.g., the head portion is disk-shaped). The head portion is shaped and adapted to abut against a surface of the structure 100, the body 12 or another section of the connection assembly 14, thereby limiting its insertion into the connection opening 20, for example. As will be described further below, the opening 20 can be elongated, extending along a length of the body 12 to enable the releasable pin 22 to slidably engage the opening 20 and move therealong.

In this embodiment, the body 12 is shaped and sized to engage a predetermined component of the structure 100. For instance, the structure 100 can include a steel column 102 having one or more splice plates 104 at a top end thereof. The body 12 is adapted to engage the splice plates 104 to enable connection thereto. As seen in FIGS. 2 and 3, the splice plates 104 can be spaced from one another, with the body 12 being adapted to engage a space or gap 103 defined between the splice plates 104. The releasable pin 22 can then be inserted through the splice plates 104 (e.g., through corresponding splice plate openings 105) and through the opening 20 of the body 12.

In some embodiments, the connection assembly 14 further includes a cradle 24 adapted to retain the releasable pin 22 in position when operating the lifting device 10. The cradle 24 can be connected to the body 12 and positioned to catch and/or retain the releasable pin 22. The cradle can catch the releasable pin such that, when the body 12 is lifted (e.g., by a crane), the cradle 24 lifts the releasable pin 22, which lifts both the body 12 and the steel column 102 due to its connection therewith. Alternatively, or additionally, the cradle can be adapted to at least partially secure the releasable pin 22 within the opening 20 of the body 12, thereby preventing accidental disengagement of the releasable pin 22 from the body.

The connection assembly 14 can include a support structure 26 adapted to secure the cradle 24 to the body 12, with the cradle defining a pocket 28 adapted to receive the head portion 22a of the releasable pin 22 therein. The pocket 28 is adapted to at least partially lock the head portion 22a therein. As will be described below, the pocket 28 is configured to block movement of the releasable pin at least in a direction parallel to its longitudinal portion 22b. In the present embodiment, the cradle 24 is adapted to be cooperatively coupled to the releasable pin to prevent disconnection thereof from the connection opening 20 without having the releasable pin abut against a bottom of the pocket 28. It is thus noted that the load transfer (e.g., during lifting of the structure 100) is accomplished via the releasable pin 22 abutting against an end of the connection opening 20, with the cradle (e.g., the pocket 28) being positioned to simply maintain the releasable pin in position within the connection opening. Therefore, the load of the structure 100 is not supported by the connection assembly 14, but by the plate body 12 thereby preventing damages to the support structure 26, among others.

For example, in this embodiment, and with reference to FIGS. 1 to 6, the support structure 26 includes a first rod section 32 connected to the body 12 and extending away therefrom. The first rod section 32 illustratively has a generally U-shaped configuration and includes a pair of branches 33 connected to the body 12, such as on opposite sides of the aperture 18 and a rounded distal end 32a. The first rod section 32 can be substantially perpendicular relative to the body 12, although it is appreciated that other configurations are possible. The support structure 26 can further include a second rod section 34 coupled to the first rod section 32 and extending therefrom in a generally downward direction such that a bottom end thereof is positioned proximate to and/or in alignment with the opening 20. The second rod section can have a generally U-shaped configuration (e.g., similar to the first rod section), having a pair of branches 35 connected to and extending from respective branches 33 of the first rod section 32 and a rounded distal end 34a. In this embodiment, the first and second rod sections 32, 34 are substantially perpendicular relative to one another such that the second rod section 34 extends parallel to the body 12 (e.g., parallel to the plane of the plate body). However, it is appreciated that other configurations are possible.

In some embodiments, the cradle 24 can be provided at the distal end of the second rod section 34 such that the head portion 22a of the releasable pin 22 is received in the pocket 28 proximate a bottom end 20b of the opening 20. In this embodiment, the pocket 28 includes one or more plates or panels 36 coupled to the second rod section 34 (e.g., at the distal end 34a thereof) and being shaped and configured to receive and at least partially hold the head portion 22a therein. More specifically, the pocket 28 illustratively includes a pair of panels 36, each having a U-shape and being connected to the second rod section 34 on respective sides (e.g., opposite one another), thereby defining a slot 38 therebetween for holding the head portion 22a, as seen in FIG. 3.

In this embodiment, the head portion 22a is adapted to slide into the slot 38 from a single direction, e.g., from above, and is complementarily shaped with respect to the pocket 28. As such, when the head portion 22a engages the slot 38, the longitudinal portion 22b is prevented from moving along its longitudinal axis as it extends through the splice plates 104 and the opening 20 of the body 12. It should be noted that, in the illustrated embodiment, the releasable pin 22 abuts against the bottom end 20b of the connection opening 20 as the head portion 22a engages the slot 38. In other words, the releasable pin 22 does not rest upon the U-shaped panels 36 during operation of the lifting device. However, it is appreciated that, in other embodiments, the releasable pin 22 can alternatively, or additionally, abut against any suitable portion of the cradle 24, including the U-shaped panels, for example.

The connection assembly 14 further includes a disconnection mechanism 40 coupled to the releasable pin 22 and operable to disengage the releasable pin 22 from the body 12 and the splice plates 104. For example, following the installation of a generally tall structure such as a steel column, the disconnection mechanism 40 can be operated from a ground surface to enable disconnection of the lifting device 10 from the steel column, It is noted that operating the disconnection mechanism from the ground enables the body 12 to be released from the structure without having to climb the structure (e.g., to manually unpin the body 12) and/or without the need for additional equipment such as aerial work platforms, which can require expensive electronical components, such as remote controlled lifting devices, while also reducing the risks associated with such aerial work.

With reference to FIG. 3, in this embodiment, the disconnection mechanism 40 includes a release cable or rope 42 connected to the releasable pin 22, such as to the head portion 22a, for pulling the releasable pin 22 free from the body 12 and the splice plates 104. The release rope 42 is adapted to enable operation thereof from the ground surface, such as after having erected the structure. In other words, the release rope 42 is sufficiently long to enable pulling on it from the ground to release the releasable pin and uncouple the body 12 from the structure 100. As seen in FIGS. 1 to 6, the support structure 26 of the connection assembly 14 can include a third rod section 44 coupled to the first rod section 32 and extending therefrom, for example, parallel to the second rod section 34. The third rod section 44 is illustratively U-shaped, similar to the first and second rod sections, and includes a rounded distal end 44a, although other configurations are possible. The third rod section 44 defines a hoop 45 through which the release rope 42 can initially pass through before extending toward a ground surface. In this embodiment, the hoop 45 is aligned with the top end 20a of the opening 20 such that, when the releasable pin 22 abuts against the top end of the opening 20, the release rope 42 is co-axial with the longitudinal portion 22b at least between the releasable pin 22 and the hoop 45.

The release mechanism 40 can also include a safety cable or rope 46 (FIG. 3) connected to the releasable pin 22 and configured to prevent the releasable pin 22 from falling to the ground once disconnected from the body 12 and the splice plates, for example. The safety rope 46 can be connected to the releasable pin 22, such as to the head portion 22a, at a first end thereof, and to the support structure 26, such as to the first rod section 32, for example. As such, once the release rope 46 is pulled to disengage the releasable pin 22 from the body 12, the releasable pin remains attached to the connection assembly 14.

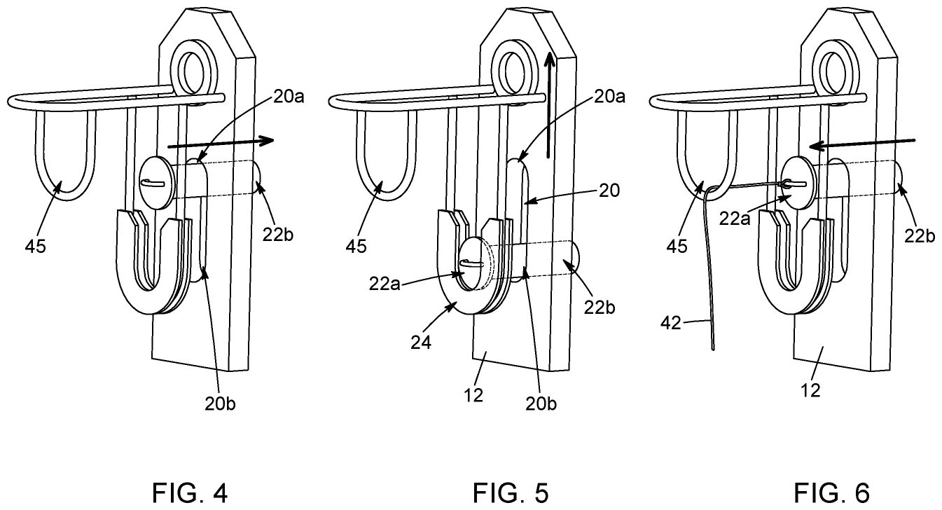

It should be understood that the body 12 is coupled between the splice plates 104 prior to erecting the structure (e.g., the steel column). In some embodiments, the structure is positioned at ground level, such as horizontally on the ground, to facilitate coupling the body 12 thereto. With reference to FIGS. 3 to 6, in this embodiment, the body 12 is initially slid between the splice plates 104 in a manner aligning a top end 20a of the opening 20 with the splice plate openings 105. This can correspond to engaging the body 12 between the splice plates 104 until the body engages a core of the steel column, for example, although other configurations are possible, such as engaging the body 12 until it abuts fasteners extending through the splice plates 104. The releasable pin 22 can then be inserted through the splice plates and the body 12, at the top end 20a of the opening 20 (FIG. 4). The body 12 can then be slid and/or pulled (e.g., manually) away from the steel column 102 such that the releasable pin 22 slides along the opening 20, and the head portion 22a engages the cradle 24, thereby locking it in place (FIG. 5). It is noted that, in this embodiment, the body 12 is moved and the releasable pin 22 remains static. It is thus noted that the static pin and the elongated opening 20 cooperate to define the range of motion of the body 12 as the longitudinal portion 22b of the pin abuts the ends 20a, 20b of the elongated opening 20.

The body 12 can be coupled to the crane (or other hoisting apparatus) at the attachment site 16, and raised upwardly (FIG. 8). It is noted that the head portion 22a remains locked within the cradle 24 as an upwardly directed force is applied to the body 12, for instance, when lifting the body 12 using the crane. With the releasable pin 22 connecting the body 12 to the splice plates 104, the steel column can be raised and erected. The crane can then carry the column to a desired location where it can be secured in place. In some embodiments, the crane maintains at least some tension in the cable connected to the attachment site 16 to prevent the body 12 from sliding downwardly between the splice plates during installation of the column. In other words, the tension in the cable can maintain the head portion 22a in the cradle 24 as the column is being secured.

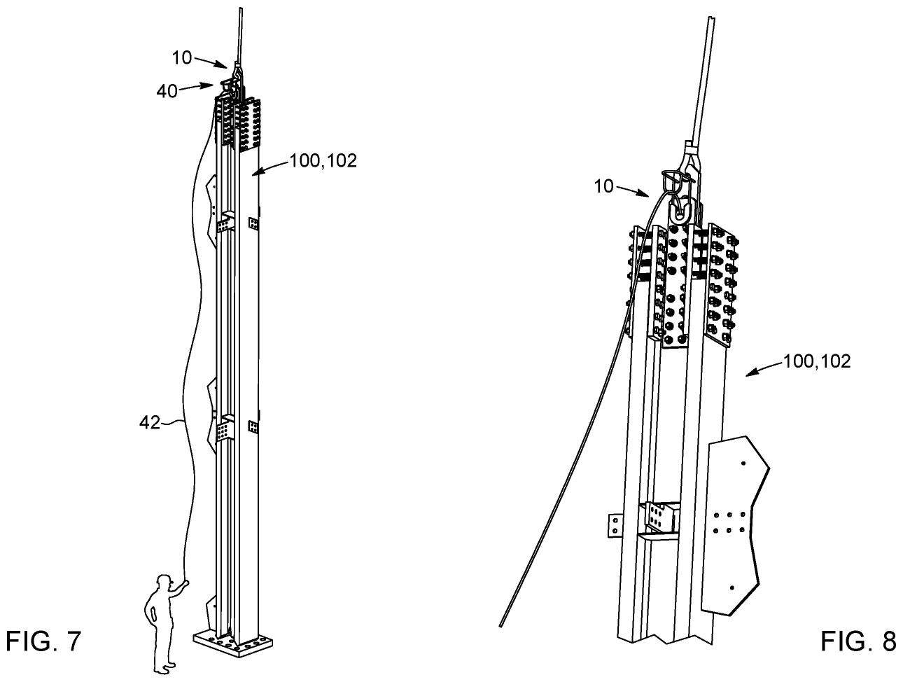

Once the steel column is raised and secured, the crane can lower the body 12, which slides down between the splice plates under gravity. In some embodiments, the body 12 and the releasable pin 22 return to a similar configuration as shown in FIG. 4, where the releasable pin 22 disengages the cradle 24 and moves proximate to or abuts the top end 20a of the opening 20. The disconnection mechanism 40 can then be operated to disengage the releasable pin 22 from the splice plates and from the body 12, thereby disconnecting the body from the steel column. In this embodiment, the disconnection mechanism 40 is operated by pulling on the release rope 42 which pulls the releasable pin axially to disengage the releasable pin 22 from the splice plates and from the body 12 (FIG. 6). As seen in FIG. 7, a person (e.g., worker) on the ground can operate the disconnection mechanism 40 by pulling on the release rope 42. It is appreciated that, due to the release rope passing through the hoop of the third rod section, the force applied to the release rope at ground surface can be redirected to be generally perpendicular to the longitudinal axis of the releasable pin 22. In other words, the support structure can redirect the force applied to the release rope so as to be co-axial with the longitudinal axis of the releasable pin.

The crane can then lower the body 12 of the lifting device 10 down to the ground to enable engagement of the body 12 with another steel column, for example. The process can then be repeated to erect additional steel columns. Moreover, a plurality of lifting devices 10 can be coupled to respective steel columns on site. As such, once a first steel column is erected/installed, the crane can simply be disconnected from the first lifting device and connected to a second lifting device, which has been pre-emptively coupled to a second steel column, to continue erecting columns in a more efficient manner.

It should therefore be appreciated from the present disclosure that the various implementations of the lifting device, or lifting attachment, and related components enable a structure, such as a steel column, to be erected (e.g., raised and secured in a generally vertical position) and disconnected from the structure via operation of the disconnection mechanism from a ground surface. The lifting device can be coupled and displaced by a hoisting apparatus, such as a crane, and can remain coupled thereto for the erection of a plurality of steel columns. The connection assembly enables the body to be connected and disconnected from each column, when desired and/or required, from the ground, and thus without having to climb or be lifted up to the lifting device to disconnect it manually, for example.

It is thus noted that the lifting device can be used to erect a plurality of structural elements in a simpler, safer, easier, faster, more accurate, more effective, more functional, more reliable and/or more versatile manner than what is possible with other conventional devices.

The present disclosure may be embodied in other specific forms without departing from the subject matter of the claims. The described example implementations are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the implementations set forth in the examples, but should be given the broadest interpretation consistent with the description as a whole.

As used herein, the terms “coupled”, “coupling”, “attached”, “connected” or variants thereof as used herein can have several different meanings depending on the context in which these terms are used. For example, the terms coupled, coupling, connected or attached can have a mechanical connotation. For example, as used herein, the terms coupled, coupling or attached can indicate that two elements or devices are directly connected to one another or connected to one another through one or more intermediate elements or devices via a mechanical element depending on the particular context.

In the present disclosure, an embodiment is an example or implementation of the lifting device. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the lifting device may be described herein in the context of separate embodiments for clarity, it may also be implemented in a single embodiment. Reference in the specification to “some embodiments”, “an embodiment”, “one embodiment”, or “other embodiments”, means that a particular feature, structure, or characteristic described in connection with the embodiments is included in at least some embodiments, but not necessarily in all embodiments.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom.

In addition, although the optional configurations as illustrated in the accompanying drawings comprises various components and although the optional configurations of the lifting device as shown may consist of certain geometrical configurations as explained and illustrated herein, not all of these components and geometries are essential and thus should not be taken in their restrictive sense, i.e., should not be taken as to limit the scope of the present disclosure. It is to be understood that other suitable components and cooperations thereinbetween, as well as other suitable geometrical configurations may be used for the implementation and use of the lifting device, and corresponding parts, as briefly explained and as can be easily inferred herefrom, without departing from the scope of the disclosure.

What is claimed is:

1. A lifting device connectable to a structure to be erected and having a pair of splice plates having respective plate openings and being spaced from one another to define a gap therebetween, the lifting device comprising:
a body shaped and adapted to engage the gap between the splice plates, the body having an attachment site adapted to be coupled to a hoisting apparatus operable to lift the body, and further has an opening defined therethrough and extending along a length thereof, the opening being positioned in a manner enabling alignment thereof with the plate openings when the body is engaged between the splice plates;
a connection assembly comprising:
a support structure connected to the body and having a cradle;
a releasable connector shaped and sized to extend through the plate openings and the opening to connect the body to the structure, the cradle being adapted to receive a portion of the releasable connector therein to at least partially secure the releasable connector in position through the plate openings and the opening when the body is lifted via the hoisting apparatus; and
a disconnection mechanism operatively coupled to the releasable connector and operable to remove the releasable connector from the plate openings and the opening to disconnect the body from the structure, wherein the disconnection mechanism is operable from a ground surface after erecting the structure using the hoisting apparatus.

2. The lifting device of claim 1, wherein the attachment site of the body includes an aperture defined through the body and spaced from the opening.

3. The lifting device of claim 1, wherein the support structure comprises a first support section connected to and extending from the body and a second support section connected to and extending from the first support section, the second support section being provided with the cradle at a bottom end thereof.

4. The lifting device of claim 3, wherein the opening has a top end and a bottom end, and wherein the second support section is shaped and adapted to position the cradle in alignment with the bottom end of the opening.

5. The lifting device of claim 4, wherein the support structure comprises a third support section comprising a hoop, the third support section being connected to and extending from the first support section to position the hoop in alignment with the top end of the opening.

6. The lifting device of claim 5, wherein the first support section comprises a first U-shaped rod connected to and extending from the body, and wherein the second and third support sections comprise second and third U-shaped rods, respectively, connected to and extending from the first U-shaped rod, each of the U-shaped rods having a rounded end.

7. The lifting device of claim 6, wherein the cradle is defined at the rounded end of the second U-shaped rod, and wherein the hoop is provided at the rounded end of the third U-shaped rod.

8. The lifting device of claim 5, wherein the first support section is substantially perpendicular relative to the body.

9. The lifting device of claim 5, wherein the second support section is substantially parallel to at least one of the third support element and the body.

10. The lifting device of claim 5, wherein the disconnection mechanism comprises a release rope connected to the releasable connector and extending through the hoop, the release rope having a first segment extending between the releasable connector and the hoop, and a second segment extending from the hoop opposite the first segment, the disconnection mechanism being operable by applying a pulling force on the second segment, the first segment being adapted to redirect the pulling force in alignment with the plate openings and the opening to disconnect the releasable connector.

11. The lifting device of claim 3, wherein the cradle comprises one or more panels connected proximate a distal end of the second support section, the one or more panels defining a slot shaped and configured to receive the portion of the releasable connector.

12. The lifting device of claim 11, wherein the releasable connector is adapted to engage the slot from a single direction.

13. The lifting device of claim 11, wherein the releasable connector comprises a pin adapted to extend through the plate openings and the opening, the pin comprising a pin head having a disk-shape and a pin body extending along a longitudinal axis, the pin head being shaped and sized to prevent movement of the pin along the longitudinal axis when engaged within the slot.

14. The lifting device of claim 13, wherein the disconnection mechanism comprises a safety rope adapted to connect the pin to the support structure and retain the pin attached to the support structure upon operation of the disconnection mechanism to disconnect the pin from the plate openings and the opening.

15. The lifting device of claim 1, wherein the structure is a steel column.

16. A method of erecting one or more structural elements using a lifting device, comprising:
engaging the lifting device at a top end of a first structural element;
connecting the lifting device to the structural element via a connector;
locking the connector in place by hoisting the lifting device vertically higher, thereby simultaneously hoisting the first structural element;
positioning the first structural element in a generally vertical position;
securing a bottom end of the first structural element in a desired location; and
operating a disconnection mechanism from a ground surface.

17. The method of claim 16, wherein the one or more structural elements include one or more steel columns.

18. A lifting attachment for erecting a structure using a hoisting apparatus, comprising:
a body connectable to a top end of the structure, the body being adapted to be coupled to the hoisting apparatus;
a connector adapted to extend through the body and the structure;
a cradle coupled to the body and adapted to receive part of the connector and secure the connector in position through the body and the structure when hoisting the body with the hoisting apparatus, thereby securing the body to the structure; and
a disconnection mechanism coupled to the connector and being operable to remove the connector from the body and the structure once the structure is erected.

19. The lifting attachment of claim 18, wherein the disconnection mechanism is configured to be operable only when the connector is disengaged from the cradle.

20. The lifting attachment of claim 18, wherein, once the structure is erected, the disconnection mechanism is configured to be operable from a ground surface.
